(19) United States
(12) Patent Application Publication
(10) Pub. No.: US 2012/0274589 A1
(43) Pub. Date: Nov. 1, 2012

(54) APPARATUS, SYSTEM, AND METHOD FOR REMOTE INTERACTION WITH A COMPUTER DISPLAY OR COMPUTER VISUALIZATION OR OBJECT

(76) Inventor: Michael J. De Angelo, Palm Springs, CA (US)

(21) Appl. No.: 13/460,656

(22) Filed: Apr. 30, 2012

Related U.S. Application Data
(60) Provisional application No. 61/480,211, filed on Apr. 28, 2011.

(51) Int. Cl. G06F 3/01; G06F 3/041

(52) U.S. Cl. 345/173; 345/156

(57) ABSTRACT

An apparatus and a method for controlling a computer display screen, field of view, visualization overlaid upon a field of view, or object using the input of a non-viewed computer touch screen, touch-sensing surface, or non-physical-contact movement-capturing device interacting with a hand or stylus eliminating distraction away from the principal field of view employed in accomplishing the objective of use.

### CROSS REFERENCE TO RELATED APPLICATION

This application claims priority to U.S. provisional patent application Ser. No. 61/480,211 filed Apr. 28, 2011. Priority to the provisional patent application is expressly claimed, and the disclosure of the provisional application is hereby incorporated herein by reference in its entirety and for all purposes.

### FIELD

The present disclosure relates to the remote interaction with, or remote manipulation of, a Graphical User Interface (GUI), or a visual representation, virtual object or real world object on a display device or in a field of view. For example, a remote input means for quickly and easily displaying and executing applications or manipulating real world objects from a computer touch screen, sensing surface, or motion-capturing device is disclosed.

### BACKGROUND

Conventional visual touch-sensitive displays on computer, mobile communications devices, or personal digital assistants (“PDA”) have required the user to directly interact with the display with their fingers or digits or other stylus while viewing that display even when that viewing distracts from the objective of use. Real world objects have not been subject to real-time or near real-time control by a hand without contact with a physical control device. Television remote controls have required that the user look down at the remote control device, and away from the display in order to identify the correct buttons to press. In distraction sensitive environments, however, such as driving an automobile or piloting aircraft or projectiles, or manipulating real world objects or robots, the user must limit, if not entirely omit, those instances of distraction thereby taking the user away from focusing on the primary field of view.

When controlling a vehicle, for example, trying to maintain situational awareness on one or more screens, especially where split second decisions are made or are required, or in any situation where the eyes need to be viewing something other than the computer touch screen, sensing surface, physical control device in hand, or motion-capturing device being used to interact with any software controls, there is a need to see a representation of a hand or fingers or digits or stylus, or their position, gestures, movement, motion, or duration of movement or motion interacting with, or visible on, a screen other than the screen, device or surface being used as an input device without giving visual attention to the physical interaction itself. By maintaining visual attention on a primary display screen other than where that physical interaction of input is occurring, there occurs faster navigation, and a reduction of distraction. Similarly, real or virtual objects in a field of view can be observed while being controlled by a computer touch screen, sensing surface, or non-physical-contact motion-capturing device, and observation of that control can also be accomplished through software visualization means showing objects, positions, and actions, operating upon a live and present field of view such as through a heads-up display or computerized eyeglasses mixing software visualizations with human eyesight, or by other means, presently under development or yet to be discovered.

Utilizing a hand or stylus without physical contact with any device, allows the user to exercise more fine-grained, more complex, and more responsive control of position and motion of real-world and virtual objects, and greater development and variance in control languages. The capture of three dimensional space and time is thereby utilized for the control of the position, motion and orientation of real world and virtual objects in a richer, more direct, and more fine grained way than interacting with a physical control device or standard touch screen.

### SUMMARY

The embodiments provided herein have utility in the area of display and visualization devices and interaction therewith without giving direct visual attention to those various means causing input to those display devices being the primary focus of attention in the primary field of view.

### BRIEF DESCRIPTION OF THE FIGURES

FIG. 1 depicts a hand on a first touch or hover screen.

FIG. 2 depicts a second display screen with a real time or near real time representation of the hand on the first touch or hover screen as on FIG. 1.

FIG. 3 also depicts a second display screen with a real time or near real time representation of the hand on the first touch or hover screen as on FIG. 1.

FIG. 4 also depicts a second display screen with a real time or near real time representation of the hand on the first touch or hover screen as on FIG. 1.

FIG. 5 depicts other forms of hand representation on the second display screen, i.e., ovals and squares representing individual digits.

FIG. 6 depicts an exemplary overall orientation between user, first touch screen, and second display. As depicted, a user views on the second display screen a representation of hand or fingers or symbols moving on first touch screen, or views an overlay upon a real world object, or is able to control a real world object.

FIG. 7 depicts a block diagram that sets forth the various layers of data interpretation. Silhouette, shadow or visualization generation layer causes any representation of a hand to appear on display screen in order to control touch or hover screen commands and functions, or alternate software layer functions, without viewing it directly or interacting directly, with the alternate software layer, or causes the exercise of control of real world objects, or causes a visualization layer over a real world field of view, or over a virtual field of view.

FIG. 8 depicts the various hand motions or gestures that may be used to manipulate the first and second display devices.

FIG. 9 depicts a hand inserted into a three-dimensional sensor or interference grid that may be used to capture outlined, fingers, position, movement, and gestures. Movements may directly map to controls and functional or virtual vehicle, or may map to existing software touch sensitive interface. Navigation may occur with or without the use of visual field of view. Visual field of view may be a computer representation or the actual field of view of the physical medium. Control field may be used with or without a representation of the hand, fingers, or movement on the second display screen. Thus, three-dimensional input becomes four-dimensional through a time counter for each gesture held.

FIG. 10 is similar to FIG. 6 but depicts an alternative exemplary embodiment. FIG. 10 depicts an exemplary overall orientation between user, first touch screen, and second display but capturing three dimensional movement from the user's hand gestures and using that information to manipulate a first and second software layer.

FIG. 11 depicts a plurality of examples of the hand gestures and movements that may be captured by the motion capture module in a four dimensional space, i.e., X, Y, and Z axes over time.

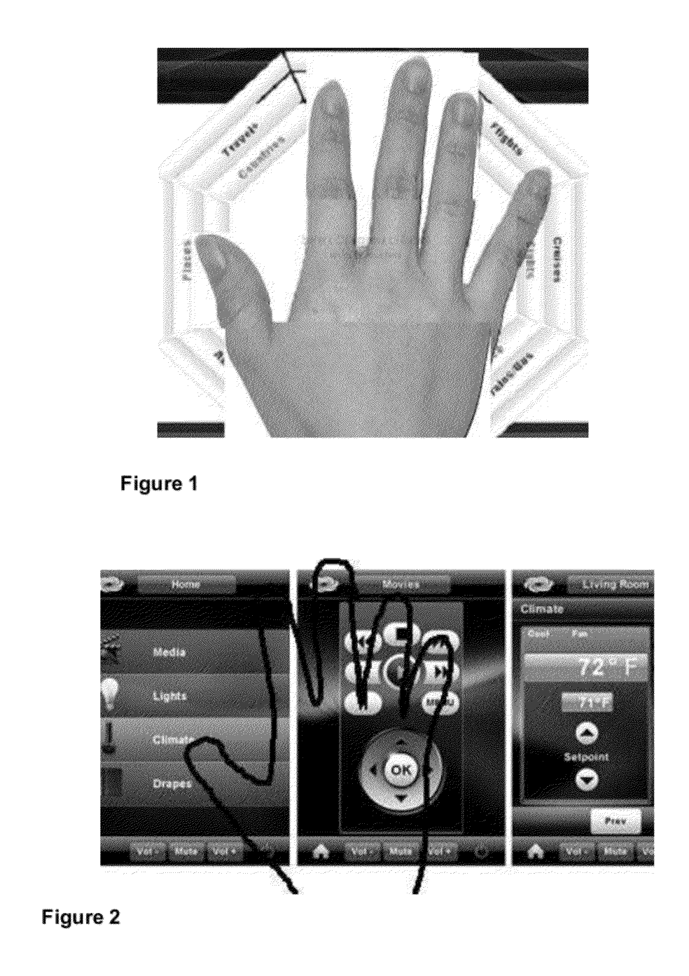

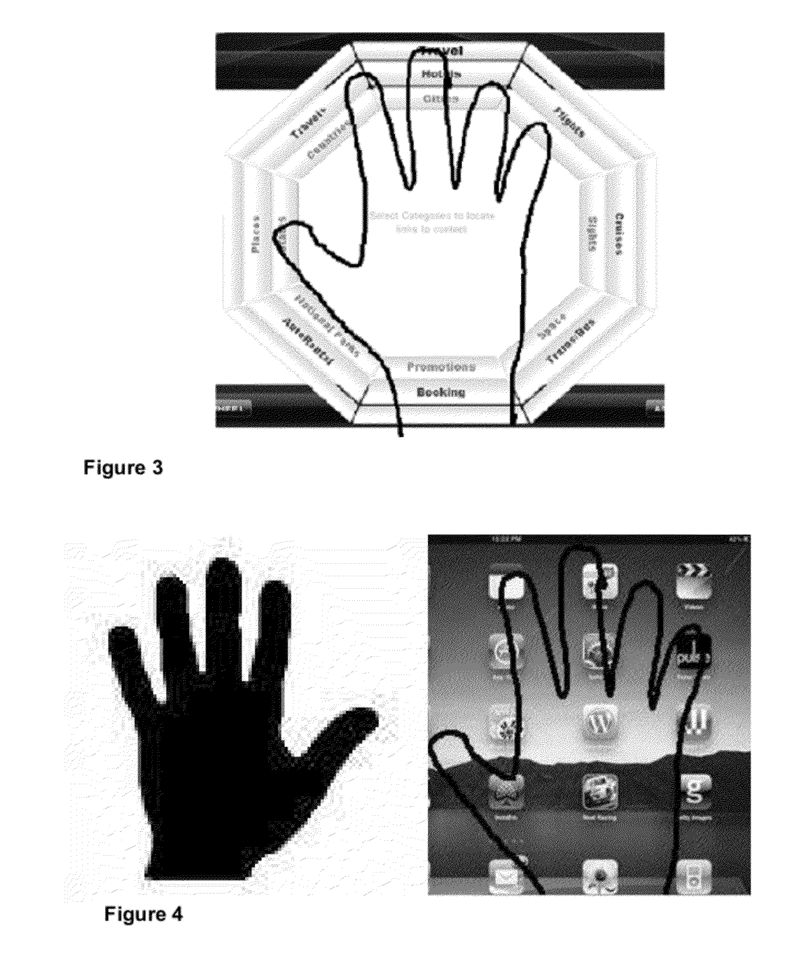

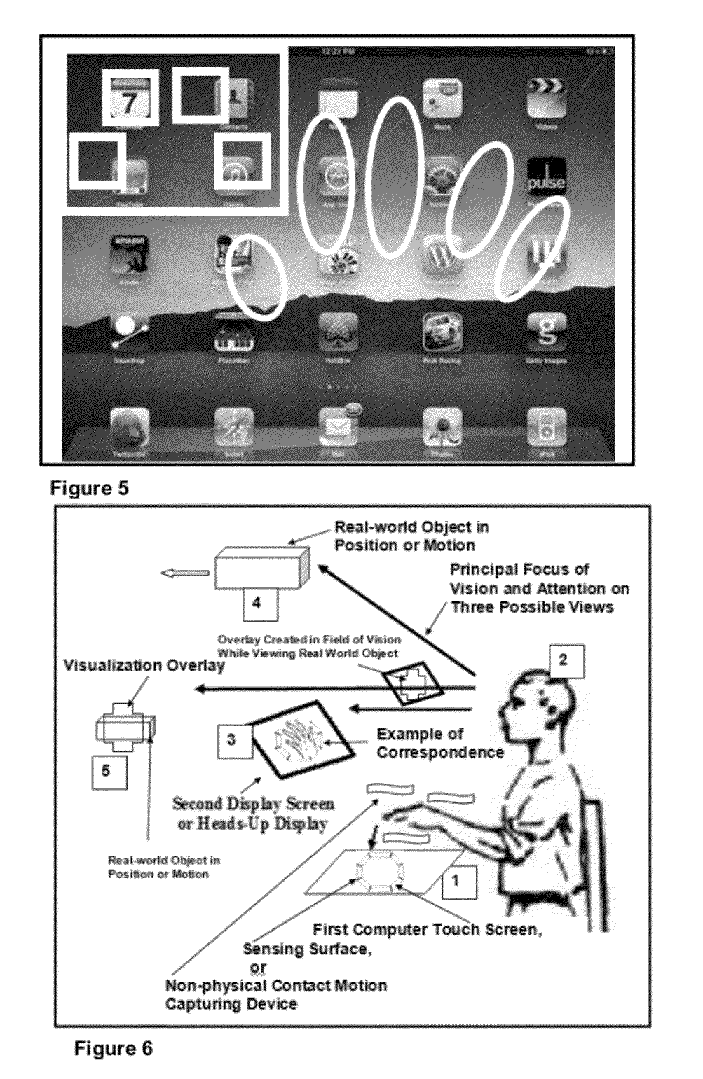

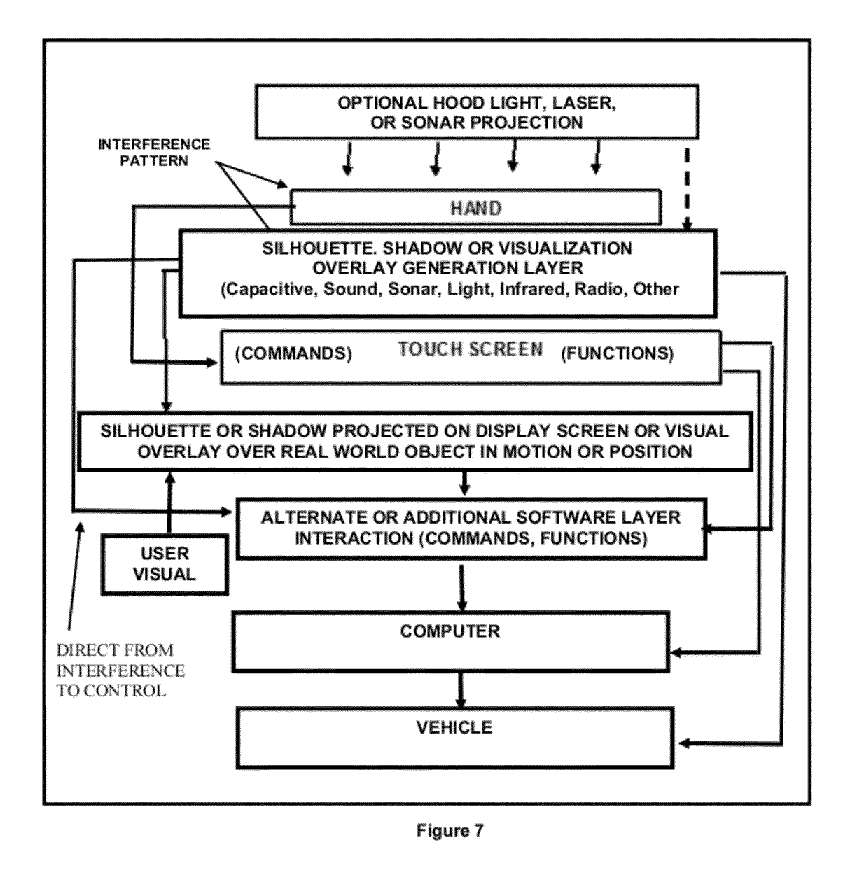

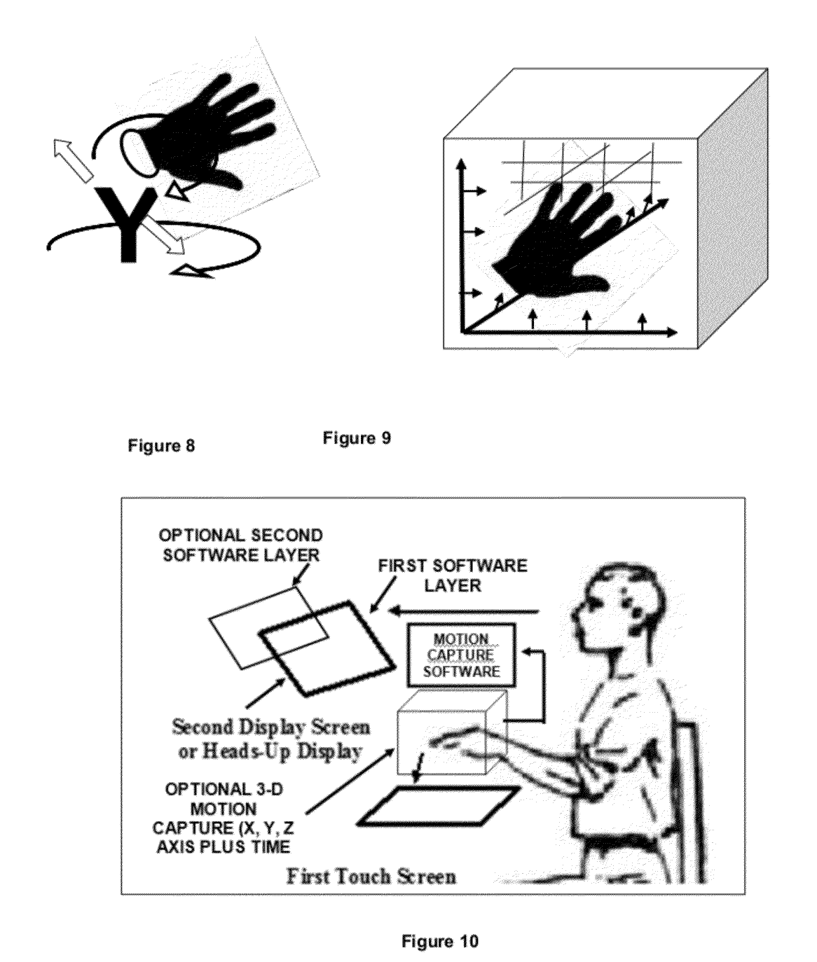

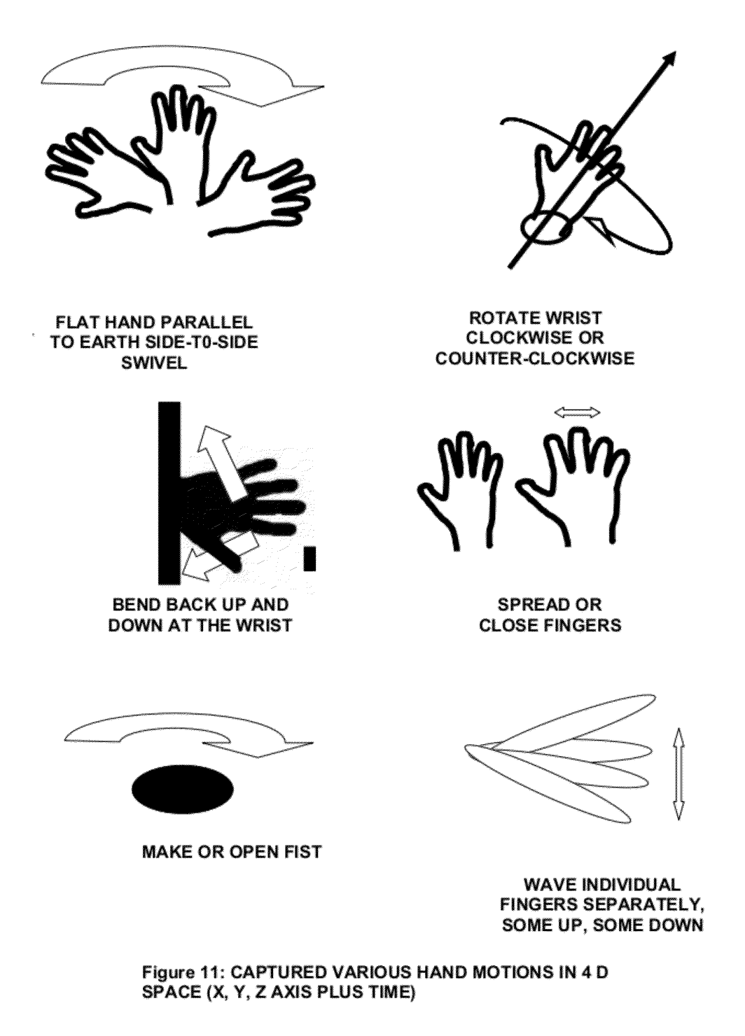

### DETAILED DESCRIPTION

In the preferred embodiment, referring now to FIG. 6, [1] a first computer touch screen, touch sensing surface, or non-physical contact motion-capturing device, being the data capture device, capable of sensing, reading, or interpreting, various kinds of hand motions, movements, positions, motions, or gestures, or duration of same is placed in proximity to a hand, approximation of a hand or stylus in order that data might be generated and transferred or captured to software being the data capture means that captures and transfers the data.

A user [2] moves the hand, digit, fingers or stylus without looking at same while viewing a second computer display screen [3], real world object in position or motion in a field of view [4], or visualization overlay [5] created by software overlaid upon a field of view, located more central to the user's vision, in order to maintain focus on the principal field of view serving the use objective, while a data capture means captures that motion in hardware and software in order to make that motion visible on the second display screen, or as an overlay upon a real world field of view, or as an overlay in the field of vision made to appear over a real world object in motion, or in order to control a real world object in motion, through the data capture device and means interacting with motion control systems on those real world objects.

In one embodiment, on a first computer touch screen, touch sensing surface, or motion-capturing device, an easily memorized or symmetric arrangement of shapes approximately corresponding to size of the human hand and reach of the fingers is also visible on a second display screen. Movement of the hand or fingers over or across the shapes may be demarcated by audible or tactile feedback upon moving across the boundaries of the shapes or between shapes, or there may be a simple physical ridge that could be felt between the shapes. One such arrangement of shapes could be concentric rings of uniform shapes, such as uniform rhomboids forming a ring, or forming inner and outer rings. Each shape shows a text label, image, color, graphic, audio producing label, icon, symbol, or distinguishing representation being part of a menu of selection of commands or controls, or if nested, with multiple rings showing categories and subcategories potentially leading to commands and controls. Movement may be used to display a representation on a second screen, in order that the first touch screen may be used in the normal manner but without viewing that touch screen, or movement may be used to directly control commands and functions visibly displayed on the display screen, without the need to physically interact with the first touch screen, or movement may be used to directly control commands and functions not visibly displayed on the display screens other than the commands and functions displayed, without the need to physically interact with the first screen. This would include a time counter to determine how long the gesture is held, and applies a rules based algorithm. For example, fingers held open may accelerate at an exponentially increasing acceleration.

In another embodiment, on a touch sensing surface, the user utilizes an arrangement of shapes demarcated by physical ridges, showing a corresponding grid or arrangement of shapes on the second display screen, with display labels showing on those shapes of a text label, graphic, audio producing label, icon, symbol, or distinguishing representation being part of a menu of selection of commands or controls, or if nested, showing categories and subcategories potentially leading to various commands and controls, to control or make a selection.

In another embodiment, a motion capturing device, without physical contact with a hand or stylus, utilizing interference patterns, recording or interpretation of any wave phenomenon, including but not limited to light, sound, radio, electrical, electro-magnetic, infrared, or other, within a space, created by movements of a hand or fingers or digits or stylus, or their position, gestures, movement, motion, or duration of movement or motion interacting with or visible on that second computer display screen, field of view, or visualization created by software overlaid upon a field of view, or upon an object in position or motion in that field of view, provides the data that is provided to the data capture means. This could include a time counter to determine how long the gesture is held, applying a software algorithm. For example, fingers held open may accelerate at an exponentially increasing acceleration, or making a fist could determine a braking speed, or the plane of a hand or rotation or swivel or a wrist could control the position, speed, orientation, altitude, angle, rotation, or other of an object in space.

Exemplary hand motions to be captured could be 1) flat open hand, down, closed fingers, 2) flat open hand, down, spreading fingers, 3) flat open hand, up, closed fingers, 4) flat open hand, up, spreading fingers 5) fist, down, 6) fist up 7) fist rotated down, 8) fist rotated up 9) fist rotated right, 10) fist rotated left, 11) flat open hand, up, rotated up at wrist, 12) flat open hand, up, rotated down at wrist, 13) other. The capture of three dimensional space and time is utilized for the control of the position, motion and orientation of real world and virtual objects in a richer, more direct, and more fine grained way than interacting with a physical control device.

Software, computer chips, electronic means, and/or circuitry integrated into, or connected with, the capturing means, translate the data captured by the capture means into software that would cause, or supply data causing, a representation or visualization corresponding to that data to be viewable on a second computer display screen, field of view, or visualization created by software overlaid upon a field of view, or cause control of a physical object in the field of view utilizing the data capture device and data capture means.

The software causes on the second computer display screen, field of view, or visualization created by software overlaid upon a field of view, directly or through an interacting software system residing on the second system, the hands, digits, and fingers and their position, movement, and gestures, or duration of same occurring on the first screen to be represented and viewable as a shadow, silhouette, outline, visualization of motion through time or space, or representation or symbol of any kind on that second computer display screen, field of view, or visualization created by software overlaid upon a field of view, or as real world objects in position or motion in order that apparatus and might control those object in their motion through space.

The second computer screen interacts with or displays the computer software program or interface that is being used or interacted with on the computer touch screen, sensing surface, or non-physical contact motion-capturing device as well as displaying over it any visual representation of the hands, digits, and fingers and their position, movement, and gestures, or duration of same occurring on the first screen in order that the user might utilize functions, commands and controls existing on the first computer touch screen, touch sensing surface, or non-physical contact motion-capturing device without the necessity of looking at them, or in order to utilize functions, commands and controls existing or visible on the second computer display screen.

Additionally, it may be advantageous to include a physical hand or wrist support to reduce fatigue when using this kind of computer control. Therefore, a wrist or hand support or harness with more than one dimension of movement may aid in the capture of rotation, waving, swivel or other motion, in order to process that motion through a computer system, while reducing hand and wrist fatigue.

One skilled in the art might see there are various means of capturing the hand and fingers and their position, movement, and gestures on a first touch or hover screen and causing a representation of it to display on a second independent display screen over or on whatever program or interface is displayed on the first touch screen, such that either the effective utilization of the first touch screen is caused by the usual interaction with the functions and commands of that touch screen, or by the representation itself of the hand and fingers interacting through a new software layer with the new or additional functions and commands of an underlying program, both without the necessity of looking at that first computer display or hover screen, or necessarily physically interacting with first touch screen.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A hardware and software apparatus comprising:
a first computer touch screen, touch-sensing surface, or non-physical-contact movement-capturing device interacting with a hand or approximation of a hand, or stylus
a second computer display screen, field of view, or visualization overlaid upon a field of view that can be viewed in interaction with the first computer touch screen, touch-sensing surface, or non-physical contact movement-capturing device without the necessity of looking at that first computer screen, sensing service or non-physical contact movement-capturing device
the use on the second computer display screen, field of view, or visualization overlaid upon a field of view, or the first computer touch screen, sensing surface, or non-physical contact movement-capturing device any geometric shapes where those shapes show a text label, color, image, graphic, audio producing label, icon, symbol, or distinguishing representation being part of a menu of selection of commands or controls

2. A hardware and software apparatus comprising:
a first computer touch screen, touch-sensing surface, or non-physical-contact movement-capturing device interacting with a hand. or stylus
at least one second computer display screen, field of view, or visualization overlaid upon a field of view showing in a real time or near real time any representation of any kind of a hand or fingers or digits or stylus, or their position, gestures, movement, motion, or duration of movement or motion interacting with or visible on that first computer touch screen.

3. The method of claim 1 where there is any kind of tactile or audible transition between the between the shapes.

4. The method of claim 2 where there is any kind of tactile or audible feedback given by first computer screen, sensing surface, or non-physical-contact movement-capturing device interacting with a hand or stylus.

5. The method of claim 2 where there is any software that captures the hand, fingers, and their position, movement and gestures or duration of same such that any symbolic representation of same is displayed on a second display screen.

6. The method of claim 2 where a user is enabled to utilize the functions or commands visible on the second display screen.

7. The method of claim 2 where the representation itself can interact with other displayed or invisible software program or functions.

8. The method of claim 2, when there is any kind of tactile or audio transition between the shapes, such as a ridge or distinct vibration.

9. A hardware and software apparatus establishing any bounds of space used to capture the gesture, motion, movement or duration of movement or motion of a hand, fingers, or digits by any means without direct physical contact with that hand, fingers, or digits.

10. The method of claim 9, where the movement of the hand, fingers, or digits in at least one axis of motion is used in order to interact with a computer, computer display screen, field of view, or vehicular or real-world object control system, whether that vehicle or real-world object is real or virtual.

11. The method of claim 9 utilizing any method to capture by any means without direct physical contact the movement of a hand or fingers in at least one axis of motion in order to interact with a computer, computer display screen, or vehicular or real-world object control system, whether that vehicle or real-world object is real or virtual.

12. The method of claim 9 where there is utilized a wrist or hand support or harness with at least one dimension of movement, to aid in the capture of any motion in order to process that motion through a computer system.

13. The method of claim 9 where an interference or sensor pattern in any wave phenomena is used to create a representation of position, movement, or motion on a computer display screen, to directly control functions and commands displayed on the screen or display, or create any visualization of motion through time or space on a computer display, field of view, or visualization overlaid upon a field of view, or to control real-world or virtual objects.

14. method of claim 9 where the recording, interpreting or sensing of motion is accomplished by any means without physical contact with the hand in order to create a representation of position, movement, or motion on a computer display screen, to directly control functions and commands displayed on the screen or display, or create any visualization of motion through time or space on a computer display, field of view, or visualization overlaid upon a field of view.
